(19) United States
(12) Patent Application Publication
(10) Pub. No.: US 2011/0032796 A1
(43) Pub. Date: Feb. 10, 2011

(54) System and method for producing an acoustic pulse using live steam

(75) Inventor: Larry W. Fullerton, New Hope, AL (US)

Correspondence Address: Mark D. Roberts, 416 Zandale Drive, Huntsville, AL, 35801, US

(73) Assignee: Cedar Ridge Research, LLC, New Hope, AL (US)

(21) Appl. No.: 12/804,871

(22) Filed: Jul. 30, 2010

Related U.S. Application Data
(60) Provisional application No. 61/273,064, filed on Jul. 30, 2009.

(51) Int. Cl. G01V 1/38

(52) U.S. Cl. 367/21; 367/15

(57) ABSTRACT

An improved system and method for seismic exploration using live steam involves creating a cavity of live steam in a body of water, the cavity of live steam imploding due to the water cooling the live steam thereby producing an acoustic pulse, receiving reflections of the acoustic pulse at one or more receivers, and processing the reflections of the acoustic pulse. The cavity of live steam can be created by controlling release valves to introduce live steam into the body of water or by introducing hydrogen and at least one of oxygen or air into the water to create a bubble and then igniting the bubble.

### CROSS-REFERENCE TO RELATED APPLICATIONS

This application claims the benefit of U.S. Provisional Application Ser. No. 61/273,064, filed Jul. 30, 2009.

### FIELD OF THE INVENTION

The present invention relates generally to a system and method for generating an acoustic pulse using live steam. More particularly, the present invention relates to a system and method for producing an acoustic pulse by introducing live steam into a body of water thereby producing an acoustic pulse that is used for seismic exploration of the floor below the water body.

### BACKGROUND OF THE INVENTION

Current systems and methods for underwater seismic exploration often involve a survey ship that uses a seismic source such as an air gun to produce an acoustic pulse, which reflects off geologic formations. Multiple receivers receive reflections of the pulse and signal processing is used to produce a map of the geologic formations. FIG. 1 depicts a typical survey ship that uses an air gun to produce an acoustic pulse that reflects off of geological formations where reflections of the pulse are received by 48 receivers attached to a streamer cable being towed behind the survey ship. Other approaches may involve receivers located on the floor of a body of water being surveyed. A common problem with air guns and other similar seismic sources used in underwater seismic exploration is that the explosion that occurs when such seismic sources are fired can cause bubble oscillation in the water that causes unwanted noise that degrades the quality of the reflections of the acoustic pulse. FIGS. 2A and 2B depict an air gun in an armed state and in a fired state, respectively, where air bubbles are shown emanating from the ports of the air gun as it is being fired. FIG. 3 depicts reflected signals having been received by different receivers that include noise corresponding to bubble oscillation. It is therefore desirable to have an improved system and method for generating an acoustic pulse for underwater seismic exploration.

### SUMMARY OF THE INVENTION

The present invention is an improved system and method for generating an acoustic pulse using live steam that is introduced into a body of water thereby producing the acoustic pulse that is used for seismic exploration of the floor below the body of water.

In accordance with one embodiment of the invention, a method for underwater seismic exploration includes the steps of creating a cavity of live steam in a body of water, the cavity of live steam imploding due to the water cooling the live steam thereby producing an acoustic pulse, receiving reflections of the acoustic pulse at one or more receives, and processing the reflections of the acoustic pulse.

Under one arrangement, the cavity of live steam is created by providing live steam to one or more steam outlets having corresponding to one or more release valve mechanisms, and opening the one or more release valve mechanisms to discharge live steam into the body of water. Under an alternative arrangement, the cavity of live steam is produced by introducing hydrogen and at least one of oxygen or air into the body of water to create a gas bubble, and igniting the gas bubble, where hydrogen and said at least one of oxygen or air may be combined in a stoichiometric process.

Under still one arrangement, water may be sprayed into the live steam cavity.

In accordance with another embodiment of the invention, a system for underwater seismic exploration includes a control system, a live steam generator for creating a live steam cavity in a body of water that implodes due to the water cooling the live steam thereby producing an acoustic pulse, and one or more receivers for receiving reflected signals of said acoustic pulse having reflected off of a geological formation.

The system may include one or more live steam outlets having corresponding one or more release valve mechanisms, the control system controlling the rate of a flow of water into said live steam generator and the timing of the opening of said one or more release valve mechanisms, the opening of the one or more release valve mechanisms allowing live steam to be released via the one or more live steam outlets into a body of water thereby creating the live steam cavity.

The live steam generator may be a superheated steam boiler employing a burnable fuel to heat water until it changes into steam, where the burnable fuel could be wood, coal, oil, or natural gas.

The live steam generator could harness a heat source such as exhaust heat from a combustion engine, heat given off by a chemical process, heat produced by electrical power, or heat produced by nuclear fission power.

The live steam generator can be a supercritical steam generator.

The system could alternatively include a live steam gun.

Under one arrangement, the live steam generator is an in situ live steam generator and may include one of a combustion chamber or a bubble, a source of hydrogen, a source of at least one of oxygen or air, and an ignition source, the hydrogen and the at least one of oxygen or air being introduced into the one of a combustion chamber or a bubble that when ignited combusts to produce the live steam cavity.

The hydrogen could be produced in situ.

The hydrogen and the at least one of oxygen or air may be combined prior to being introduced into the combustion chamber.

The hydrogen may be produced in situ prior to being combined with the at least one of oxygen or air.

The system may further include a nozzle and atomized water.

The system may further include a Bernoulli water atomizer.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts a survey ship using a air gun seismic source and towing a streamer cable having 48 receivers for receiving signal reflections from geologic formations beneath a sea floor;

FIGS. 2A and 2B depict an air gun in an armed state and in a fired state, respectively;

FIG. 3 depicts received reflected signals having noise corresponding to bubble oscillations occurring when the air gun is fired;

FIGS. 4A and 4B depict a live steam gun in an armed state and in a fired state, respectively;

FIG. 5 depicts a received reflected signal having minimal noise due to their not being bubble oscillations when the live steam gun is fired;

FIG. 6 depicts an exemplary system for producing an acoustic pulse using live steam;

FIG. 7 depicts an exemplary method for producing an acoustic pulse using live steam;

FIGS. 8A and 8B depict exemplary in situ live steam generators;

FIGS. 9A and 9B depict exemplary live steam guns that generate live steam in situ consistent with FIGS. 8A and 8B, respectively;

FIGS. 10A and 10B depict alternative exemplary live steam guns that generate live steam in situ;

FIGS. 11A and 11B depict variations of the live steam gun of FIG. 9B that illustrate use of a nozzle and atomized water; and

FIGS. 12A-12D depict alternative exemplary systems for producing an acoustic pulse using live steam generated in situ.

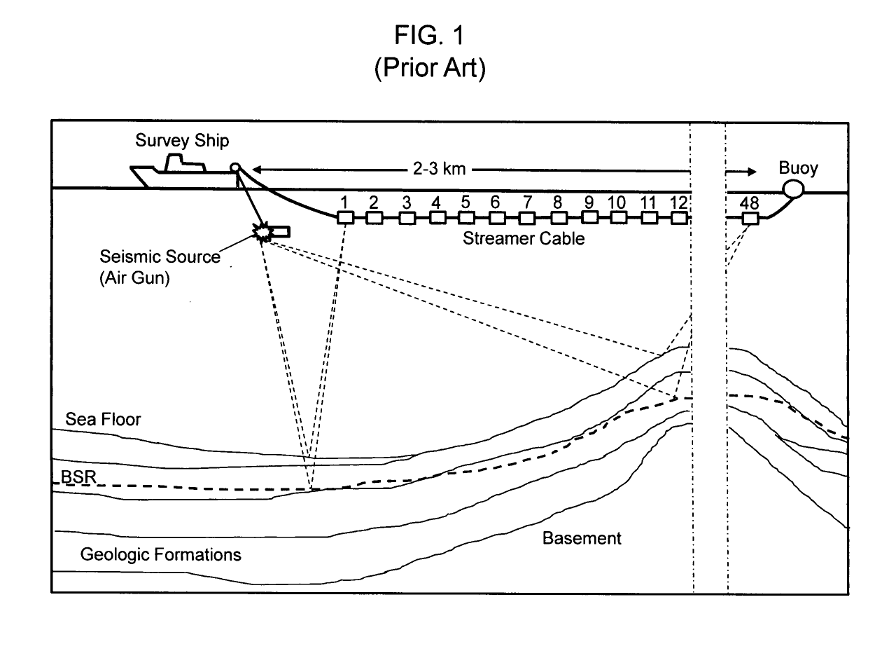

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention provides an improved system and method for producing an acoustic pulse using live steam.

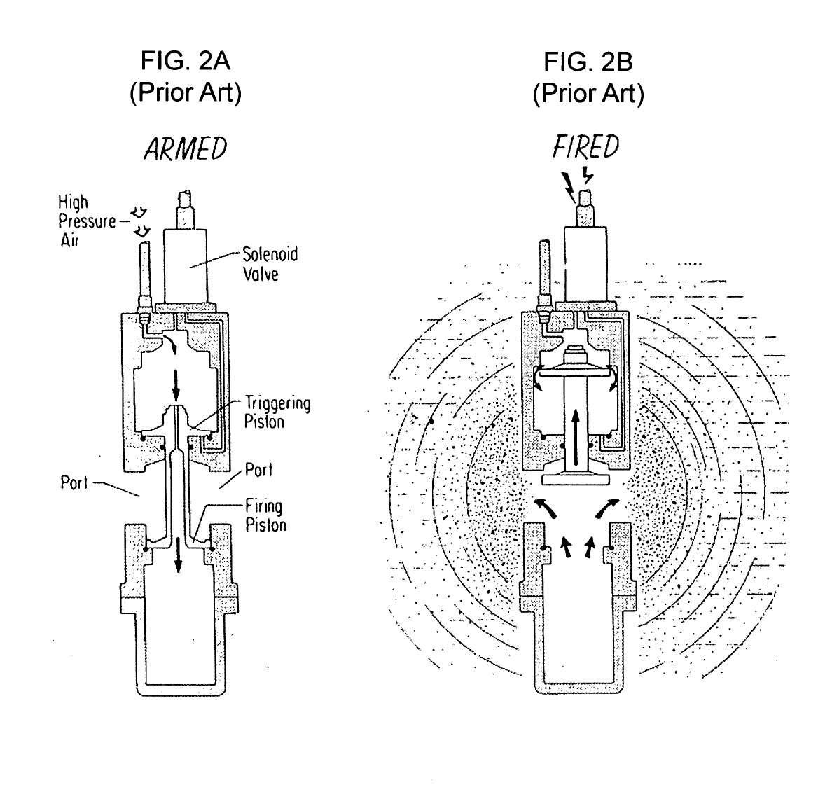

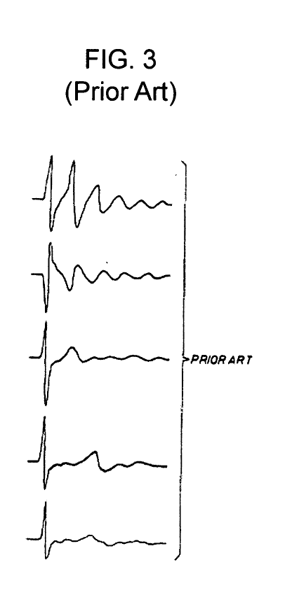

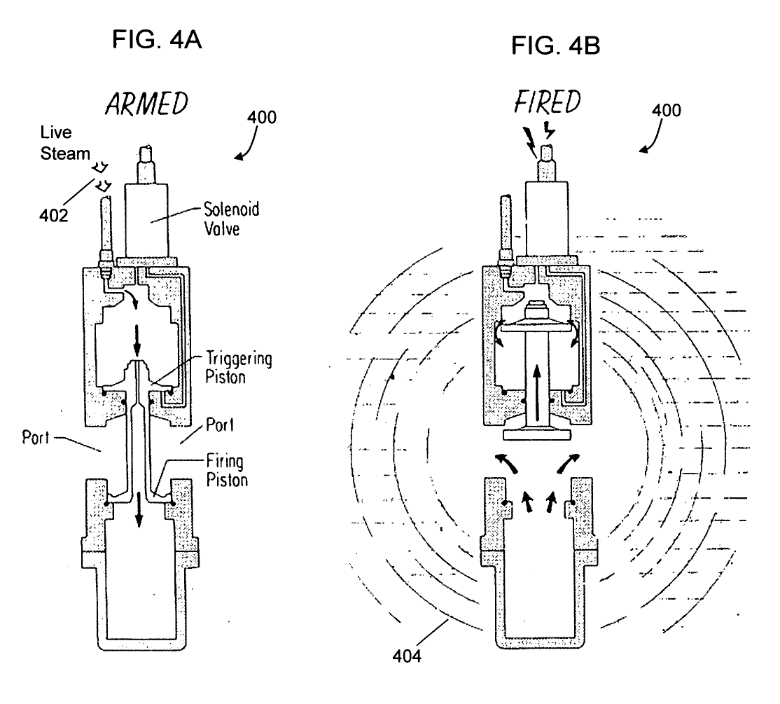

FIGS. 4A and 4B depict a live steam gun 400 in an armed state and in a fired state, respectively. Referring to FIG. 4A, the live steam gun 400 functions the same as the conventional air gun of FIG. 2A except that it receives live steam 402 instead of high pressure air. Referring to FIG. 4B, when the live steam gun is fired an acoustic pulse 404 is produced but without bubble oscillation in the water.

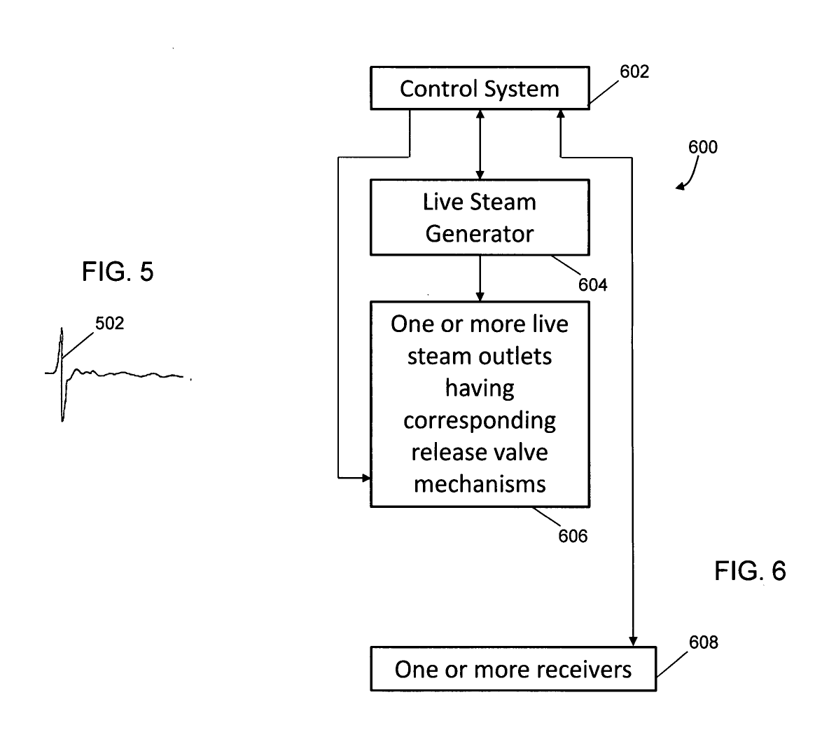

FIG. 5 depicts a received reflected signal 502 having minimal noise due to their not being bubble oscillations when the live steam gun 400 is fired.

FIG. 6 depicts an exemplary system 600 for producing an acoustic pulse using live steam. The system 600 includes a control system 602, a live steam generator 604, and one or more live steam outlets having corresponding release valve mechanisms 606, and one or more receivers 608 for receiving reflected signals of a produced acoustic pulse having reflected off of a geological formation. The live steam generator 604 may comprise a superheated steam boiler employing any of various types of burnable fuel, for example wood, coal, oil, or natural gas, to heat water until it changes into steam. The live steam generator 604 may harness various types of heat sources; for example, exhaust heat from a combustion engine. Alternatively, the live steam generator 604 may receive heat given off by a chemical process. The live steam generator may use electrical power or nuclear fission power as a heat source. Furthermore, the live steam generator 604 may comprise a supercritical steam generator. The control system 602 controls the steam generator including controlling the rate of flow of water into the steam generator and the when release valve mechanisms are opened. When it is desirable to produce an acoustic pulse, the control system 602 causes the one or more release valve mechanisms 606 to open allowing live steam to be released via one or more live steam outlets into a body of water, for example, sea water. Introduction of the live steam into the sea water creates a live steam cavity in the sea water that will implode in a manner similar to ordinary cavitation due to the sea water rapidly cooling the live steam, which will rapidly go from a high pressure to zero pressure. This implosion produces an acoustic pulse 404 without producing bubble oscillation in the water as does an air gun. The acoustic pulse 404 reflects off of geological formations beneath the floor of the sea and the one or more receivers 608 receive the reflected signals that can then be processed to for seismic exploration purposes. Under one arrangement, the system 600 comprises a live steam gun 400 that functions like an air gun but uses live steam instead of high pressure air.

One skilled in the art will recognize that any of well known techniques applicable to seismic sources can be used with the system of the present invention such as beam steering techniques, etc. Furthermore, the system of the present invention can be used in place of other types of seismic sources in various other applications requiring them, for example, bore well oil exploration.

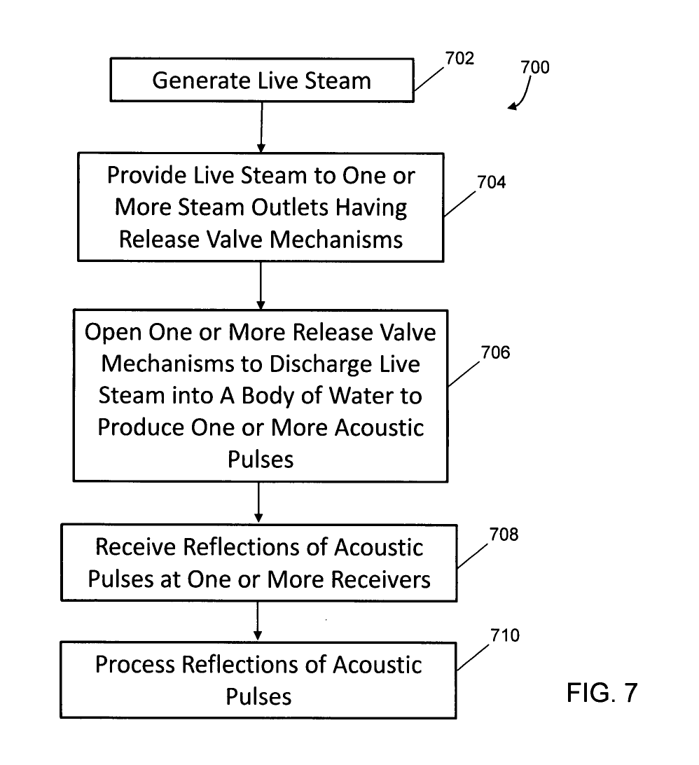

FIG. 7 depicts an exemplary method 700 for producing an acoustic pulse using live steam. The method 700 comprises the steps of generating live steam 702, providing the live steam to one or more steam outlets having release valve mechanisms 704, opening one or more valve mechanisms to discharge live steam into a body of water to produce one or more acoustic pulses 706, receiving reflections of acoustic pulses at one or more receivers 708, and processing the reflections of the acoustic pulses 710.

Refinements to the invention include:
Spraying water into the live steam cavity to increase the cooling rate.
Replacing a bulky physical plant requirement for a live steam generator by generating live steam in situ (i.e., as it is needed).

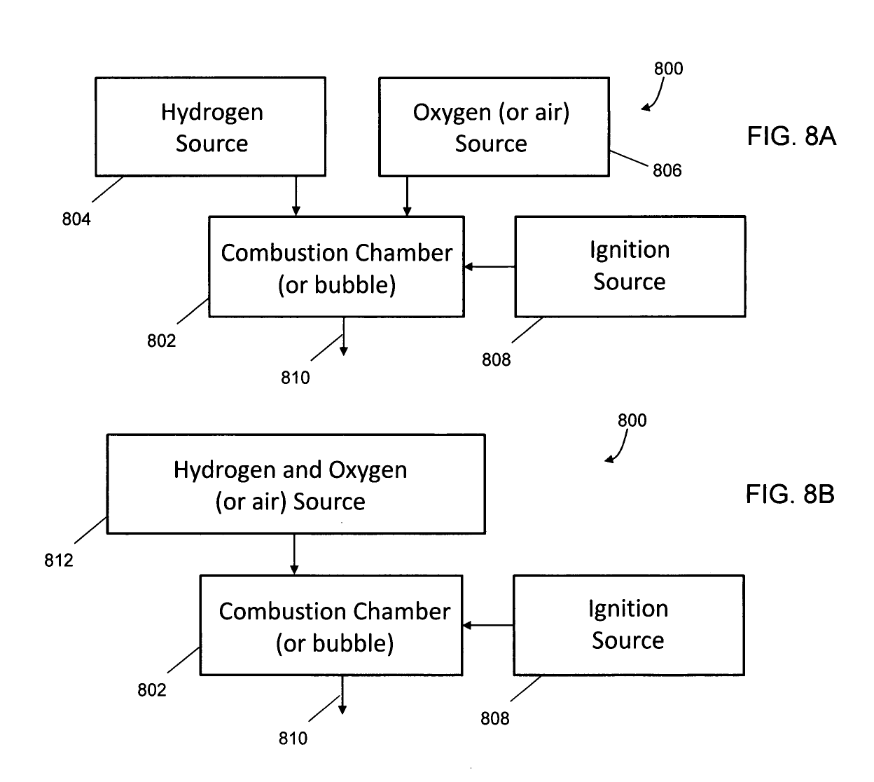

FIGS. 8A and 8B depict exemplary in situ live steam generators. FIG. 8A depicts an in situ live steam generator 800 comprising a combustion chamber (or bubble) 802 having a hydrogen source 804, an oxygen (or air) source 806, and an ignition source 808. The hydrogen and oxygen would be introduced to create a gas bubble that when ignited combusts to produce live steam 810 in a process known as conflagration. Under one arrangement the gases are combined in a stoichiometric process such that no residual un-reacted gases remain after combustion and there are no bubble oscillations. In a preferred embodiment, the hydrogen source 804 would produce hydrogen in situ. FIG. 8B depicts an in situ live steam generator 800 comprising a combustion chamber (or bubble) 802 having a hydrogen and oxygen (or air) source 812, and an ignition source 808. The generator 800 functions the same as the generator of FIG. 8A except the hydrogen and oxygen (or air) are combined prior to being introduced into the combustion chamber (or bubble) 802. In a preferred embodiment, the hydrogen would be produced in situ prior to being combined with the oxygen (or air).

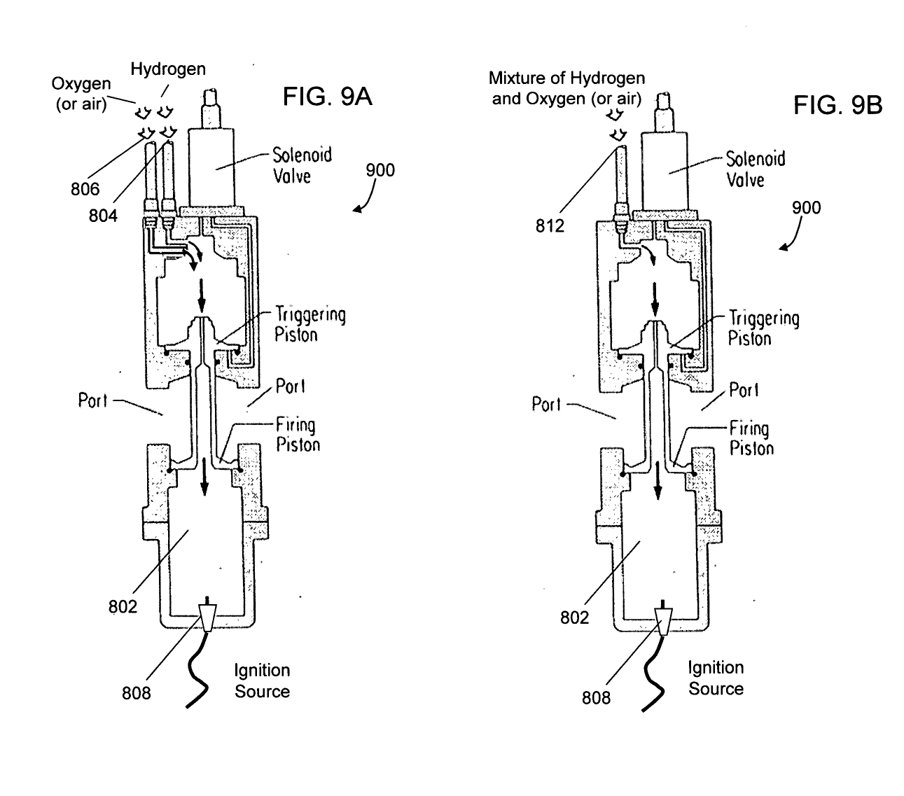

FIGS. 9A and 9B depict exemplary live steam guns 900 that generate live steam in situ consistent with FIGS. 8A and 8B, respectively. Referring to FIG. 9A, the live steam gun 900 of FIG. 9A functions much like that of the live steam gun 400 of FIG. 4a except the live steam source 402 of FIG. 4A is replaced by a hydrogen source 804 and an oxygen (or air) source 806. An added ignition source 808 ignites the hydrogen and oxygen gases after the firing piston has moved to open the ports such that combustion of the gases generates live steam in situ, which then exits the ports to produce the acoustic pulse. The live steam gun of FIG. 9B is essentially the same as the live steam gun of FIG. 9A except it receives a mixture of hydrogen and oxygen (or air) form a hydrogen and oxygen or air source 812.

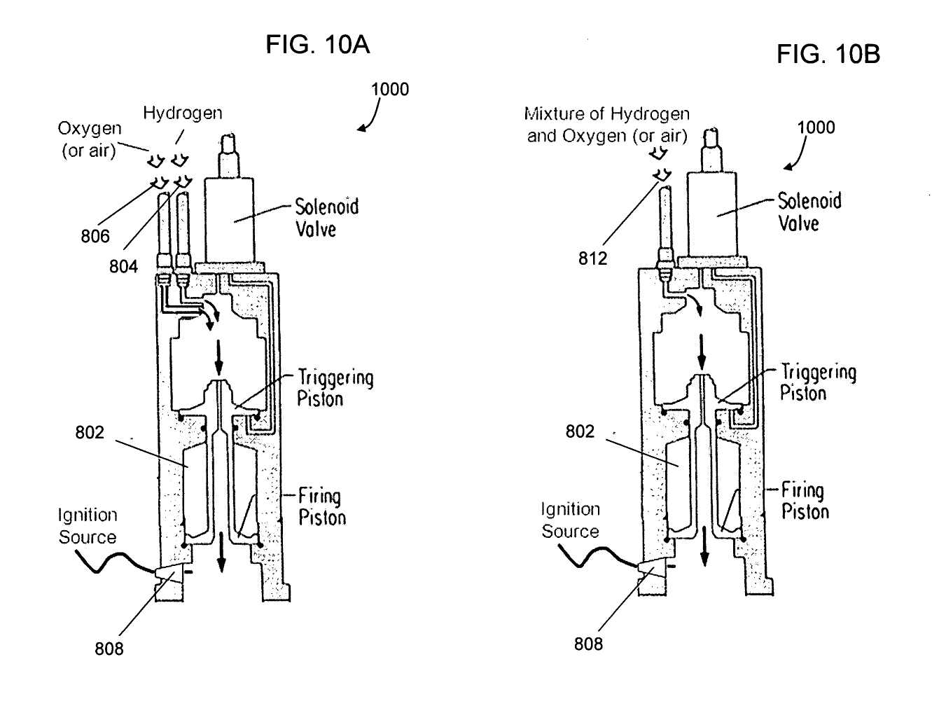

FIGS. 10A and 10B depict alternative exemplary live steam guns 1000 that generate live steam in situ. The two live steam guns 1000 are similar to those of FIGS. 9A and 9B except the two side ports are replaced by one open port at the bottom of the guns. When the top cavity fills with gas it dispels sea water through the hole in the center. When the firing piston is moved to the top position it forces the gas into the bottom cell 802 where it is ignited.

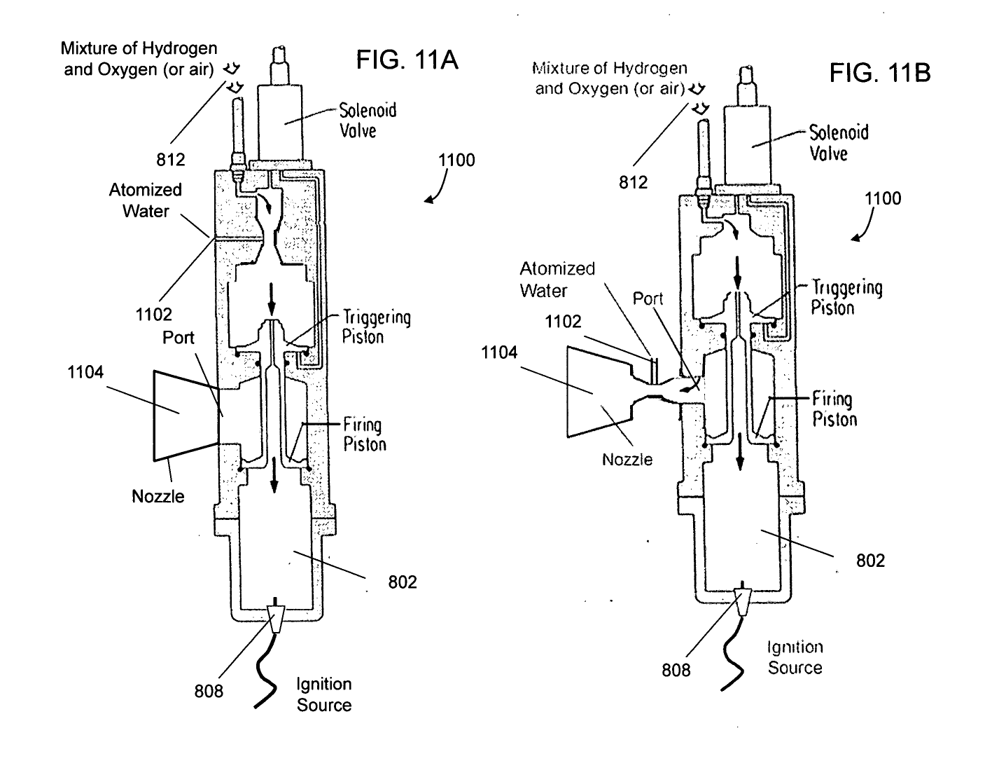

FIGS. 11A and 11B depict variations of the live steam gun of FIG. 9B that illustrate use of an optional nozzle and optional atomized water. Referring to FIG. 11A, the top cavity has been modified to include a Bernoulli water atomizer 1102, which will provide atomized water used to control the combustion of the hydrogen and oxygen (or air). The right port has been removed and the left port is shown having a nozzle 1104 used to control the shape of the gas bubble exiting the port. One skilled in the art will recognize that many different known shapes of nozzles can be used to produce a desired shape of the gas bubble. In FIG. 11B, the Bernoulli water atomizer 1102 is located between the port and the nozzle 1104. In alternative arrangements, the ignition source shown located in the bottom cavity could instead be located such that combustion occurs inside the nozzle. One skilled in the art would also recognize that separate sources of hydrogen and oxygen (or air) could be used like that of FIG. 9A.

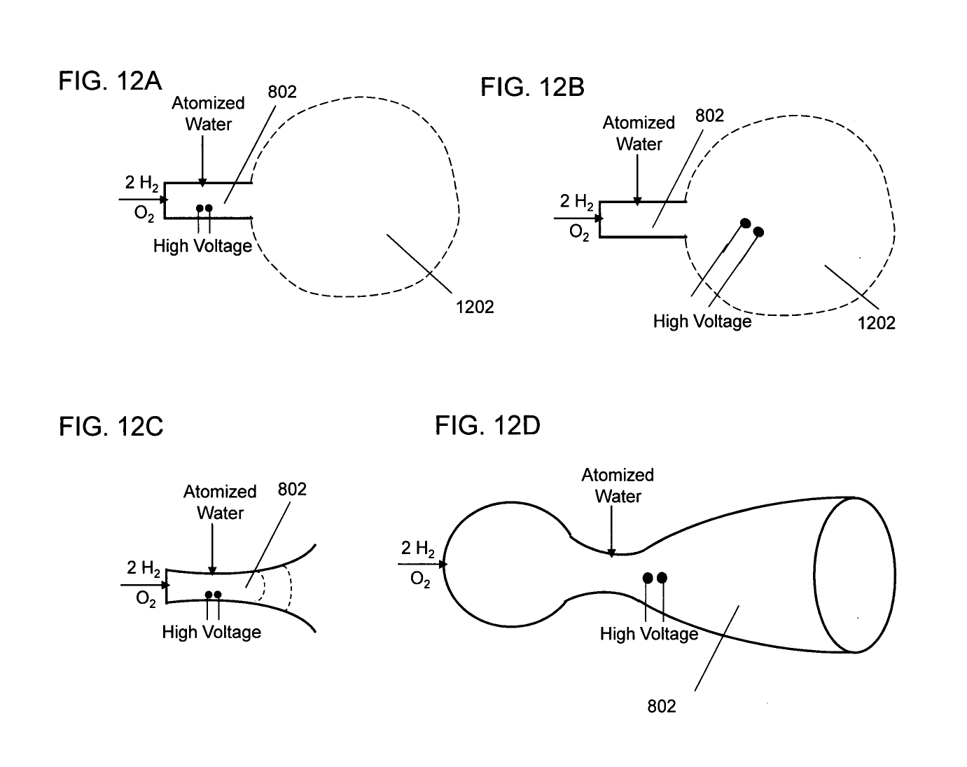

FIGS. 12A-12D depict alternative exemplary systems for producing an acoustic pulse using live steam generated in situ. Referring to FIGS. 12A and 12B, hydrogen, oxygen, and atomized water are combined in a chamber 802 to produce a gas bubble 1202 within water that when ignited produces live steam that produces an acoustic pulse, where the difference between the two systems is the location of the source of ignition (i.e., in the chamber or in the bubble). FIG. 12C depicts a horn-shaped combustion chamber 802 and FIG. 12D depicts a combustion chamber 802 resembling a rocket engine. One skilled in the art will recognize that many different variations are possible to produce in situ live steam in accordance with the present invention.

Moreover, there are many other uses of the exemplary live-steam based systems described herein including defense systems (e.g., engaging enemy frogmen beneath a ship), propelling an object (e.g., a underwater submersible or torpedo), descaling the walls of water wells, and the like.

While particular embodiments of the invention have been described, it will be understood, however, that the invention is not limited thereto, since modifications may be made by those skilled in the art, particularly in light of the foregoing teachings.

1. A method for underwater seismic exploration, said method comprising the steps of:
creating a cavity of live steam in a body of water, said cavity of live steam imploding due to the water cooling the live steam thereby producing an acoustic pulse;
receiving reflections of said acoustic pulse at one or more receivers; and
processing the reflections of said acoustic pulse.

2. The method of claim 1, further comprising the steps of:
providing live steam to one or more steam outlets having corresponding to one or more release valve mechanisms; and
opening said one or more release valve mechanisms to discharge live steam into said body of water to create said cavity of live steam.

3. The method of claim 1, further comprising the step of:
spraying water into the live steam cavity.

4. The method of claim 1, further comprising the steps of:
introducing hydrogen and at least one of oxygen or air into said body of water to create a gas bubble; and
igniting said gas bubble to create said cavity of live steam.

5. The method of claim 4, wherein said hydrogen and said at least one of oxygen or air are combined in a stoichiometric process.

6. A system for underwater seismic exploration, comprising:
a control system;
a live steam generator for creating a live steam cavity in a body of water that implodes due to the water cooling the live steam thereby producing an acoustic pulse; and
one or more receivers for receiving reflected signals of said acoustic pulse having reflected off of a geological formation.

7. The system of claim 6, further comprising:
one or more live steam outlets having corresponding one or more release valve mechanisms, said control system controlling the rate of a flow of water into said live steam generator and the timing of the opening of said one or more release valve mechanisms, said opening of said one or more release valve mechanisms allowing live steam to be released via said one or more live steam outlets into a body of water thereby creating said live steam cavity.

8. The system of claim 6, wherein said live steam generator comprises a superheated steam boiler employing a burnable fuel to heat water until it changes into steam.

9. The system of claim 7, wherein say burnable fuel is at least one of wood, coal, oil, or natural gas.

10. The system of claim 6, wherein said live steam generator harnesses a heat source.

11. The system of claim 10, wherein said heat source is one of exhaust heat from a combustion engine, heat given off by a chemical process, heat produced by electrical power, or heat produced by nuclear fission power.

12. The system of claim 6, wherein said live steam generator comprises a supercritical steam generator.

13. The system of claim 6, further comprising:
a live steam gun.

14. The system of claim 6, wherein said live steam generator is an in situ live steam generator.

15. The system of claim 14, wherein said in situ live steam generator comprises:
one of a combustion chamber or a bubble;
a source of hydrogen;
a source of at least one of oxygen or air; and
an ignition source, said hydrogen and said at least one of oxygen or air being introduced into said one of a combustion chamber or a bubble that when ignited combusts to produce said live steam cavity.

16. The system of claim 14, wherein said source of hydrogen produces hydrogen in situ.

17. The system of claim 14, wherein said hydrogen and said at least one of oxygen or air are combined prior to being introduced into the combustion chamber.

18. The system of claim 14, wherein said hydrogen is produced in situ prior to being combined with said at least one of oxygen or air.

19. The system of claim 6, further comprising:
a nozzle; and
atomized water.

20. The system of claim 6, further comprising:
a Bernoulli water atomizer.
